(19) United States
(12) Patent Application Publication
(10) Pub. No.: US 2019/0040849 A1
(43) Pub. Date: Feb. 7, 2019

(54) SOLAR-THERMAL POWER GENERATOR

(71) Applicant: GRAVITY WELLS TECHNOLOGY, INC., Bronx, NY (US)

(72) Inventor: KENT BUTLER, BRONX, NY (US)

(73) Assignee: GRAVITY WELLS TECHNOLOGY, INC., Bronx, NY (US)

(21) Appl. No.: 15/668,740

(22) Filed: Aug. 4, 2017

(51) Int. Cl. F03G 6/04

(52) U.S. Cl. CPC F03G 6/045

(57) ABSTRACT

The present invention features a solar-thermal power generator. The generator makes use of solar energy to heat a component of the generator which leads to the heating of air or fluid within the generator. The rise of the heated air of fluid is channeled towards turbines which turn to produce electrical power.

### FIELD OF THE INVENTION

The present invention relates, in general, to solar-thermal power generator using solar heating and applicable structures, specifically, a generator that uses solar and thermal energy to produce electrical power.

### BACKGROUND OF THE INVENTION

Solar energy, as transmitted via rays has been harnessed to generate power in several ways using different devices, including, without limitation, solar panels. However, the applications do not take advantage of fluid that are also heated because of the rays' impact on surfaces. This invention seeks to take advantage of heated fluid around heated surfaces and use the same to generate electrical power.

### SUMMARY OF THE INVENTION

An aspect of an embodiment of the present invention contemplates a thermal power generator, which may include: an outer structure, having a transparent surface, where the outer structure may itself have a chimney portion. The chimney portion may include top and bottom portions. The generator may include an inner structure, having a darkened surface and positioned within the outer structure, where the inner structure comprises of an interior enclosure within, at least one turbine mounted at the top of the chimney portion, a channel leading from the interior enclosure's top to the at least one turbine, and a plurality of Fresnel lenses, positioned around the circumference of the chimney's bottom portion, where the plurality of Fresnel lenses are angled to direct sun or solar rays onto the inner structure's surface. In an aspect of an embodiment of the present invention, mirrors and/or other reflective material may also be used to direct the solar rays onto the inner structure's surface.

In an aspect of an embodiment of the present invention, the generator may also include a plurality of air inlets at the outer structure's base.

In an aspect of an embodiment of the present invention, the inner structure of the generator is made of a heat conductive metal.

In an aspect of an embodiment of the present invention, the outer structure of the generator is made of and one of: glass, plastic.

In an aspect of an embodiment of the present invention, the generator may also include a plurality of legs extending from the outer structure's base, where the legs enable air to enter space between the outer and inner structures.

In an aspect of an embodiment of the present invention, the outer and inner structures of the generator may be connected by a plurality of cross bars.

Additional aspects, objectives, features and advantages of the present invention will become apparent from the following description of the preferred embodiments with reference to the attached drawings.

### BRIEF DESCRIPTION OF THE DRAWINGS

FIG. 1 illustrates a perspective view of a thermal power generator according to an aspect of an embodiment of the present invention.

FIGS. 2A & 2B illustrate a perspective views of a thermal power generator in an exemplary use according to an aspect of an embodiment of the present invention.

### DETAILED DESCRIPTION OF THE INVENTION

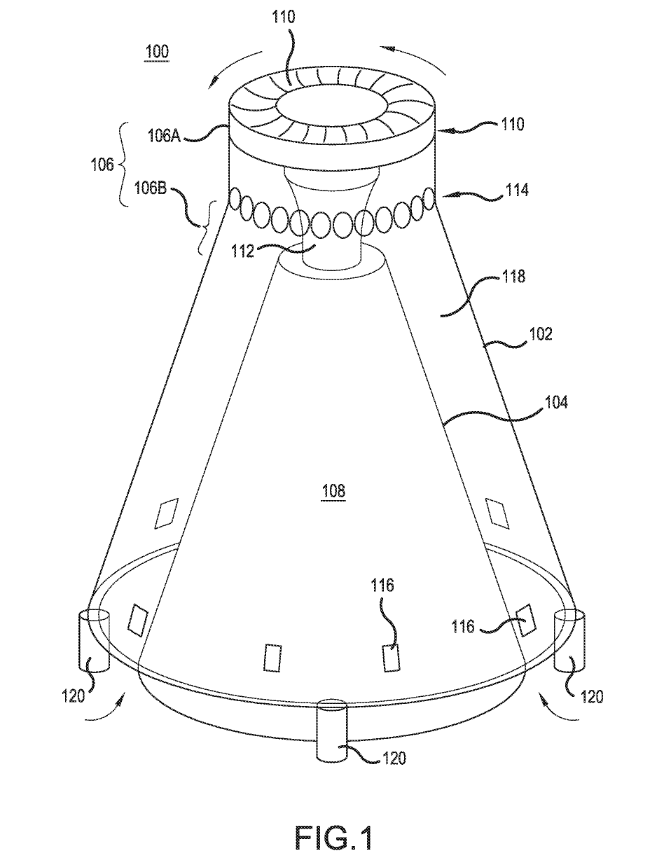

Referring now to FIG. 1 a perspective view of a thermal power generator 100 is shown according to an aspect of an embodiment of the present invention. Thermal power generator 100 includes outer structure 102 having a transparent surface, where outer structure 102 may itself have a chimney portion 106. In an aspect of an embodiment of the present invention, outer structure 102 of generator 100 is made of and one of: glass, plastic. In an aspect of an embodiment of the present invention, outer and inner structure 104s of generator 100 may be connected by a plurality of cross bars.

Chimney portion 106 may include top and bottom portions, 106A and 106B. Within outer structure 102 is inner structure 104. Inner structure 104, in one aspect of an embodiment of the present invention, may have a darkened surface and may include interior enclosure 108 within. In an aspect of an embodiment of the present invention, the inner structure 104 of generator 100 may be made of a heat conductive metal.

In an aspect of an embodiment of the present invention, generator 100 may include one or more turbines 110 mounted at the top of chimney portion 106. Channel 112, within outer structure 102, leads from interior enclosure 108's top to turbine(s) 110. Channel 112, in an aspect of an embodiment of the present invention, is structurally configured to enable flow of heated air or fluid upward from interior enclosure 108 up to turbine(s) 110. Turbine(s) 110, in an aspect of an embodiment of the present invention, are connected with electrical generation components (not shown) that enable power generation when turbines(s) 110 rotate with the upward flow of air or fluid.

In an aspect of an embodiment of the present invention, positioned at or around the circumference of chimney 106's bottom portion are a plurality of any one or more of Fresnel lenses, parabolic mirrors 114. It should be noted that element 114 is not limited to Fresnel lenses but may be any reflective surface, including, without limitation, mirrors of all kinds, a combination of mirrors and lenses, lenses etc. The plurality of Fresnel lenses 114 may be angled to direct sun or solar rays onto inner structure 104's surface.

In an aspect of an embodiment of the present invention, generator 100 may also include a plurality of air inlets 116 at outer structure 102's base. Inlets 116 allow for air flow into space 118 between outer structure 102 and inner structure 104.

In an aspect of an embodiment of the present invention, generator 100 may also include a plurality of legs extending from outer structure 102's base, where the legs enable air to enter space 118 between outer structure 102 and inner structure 104.

As Fresnel lenses 114 direct sun or solar rays onto inner structure 104, the rays pass through the transparent surface of outer structure 102 to heat the surface of inner structure 104. The blackened and heat conductive surface of inner surface 104 enable quick heating. With inner structure 104's heating, the air or fluid within interior enclosure 108 is heated as well. The heated air or fluid then expands and rises upwards. As the volume of space 118 is taken up by the expanded air or fluid, the density of the air or fluid within space 118 decreases and the air or fluid then rises towards turbine(s) 110. Blades of turbine(s) 110 being angled to meet the upward flow of the air or fluid then enable turbine(s) 110 to begin to rotate. Rotation of turbine(s) 110 then, in conjunction with electrical generation components (not shown) enable the desired power generation.

In another aspect of an embodiment of the present invention, air within interior enclosure 108 are also heated, and, as the heated air or fluid expands, heated air or fluid rises up through the top of inner structure 104, through channel 112 to turbine(s) 110 to enable rotation of turbine(s) 110 leading to power generation. In an aspect of an embodiment of the present invention, the heated airflow from within interior enclosure 108 may complement the airflow from space 118.

In an aspect of an embodiment of the present invention, interior enclosure 108 may open to space 118 with all the heated airflow (or fluid) rising without channel 112 to turbine(s) 110.

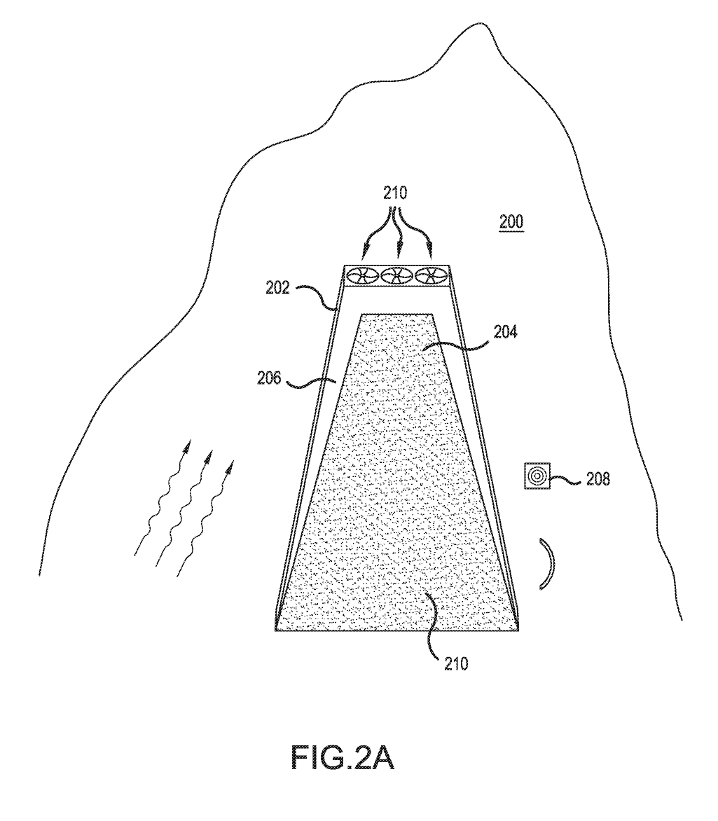

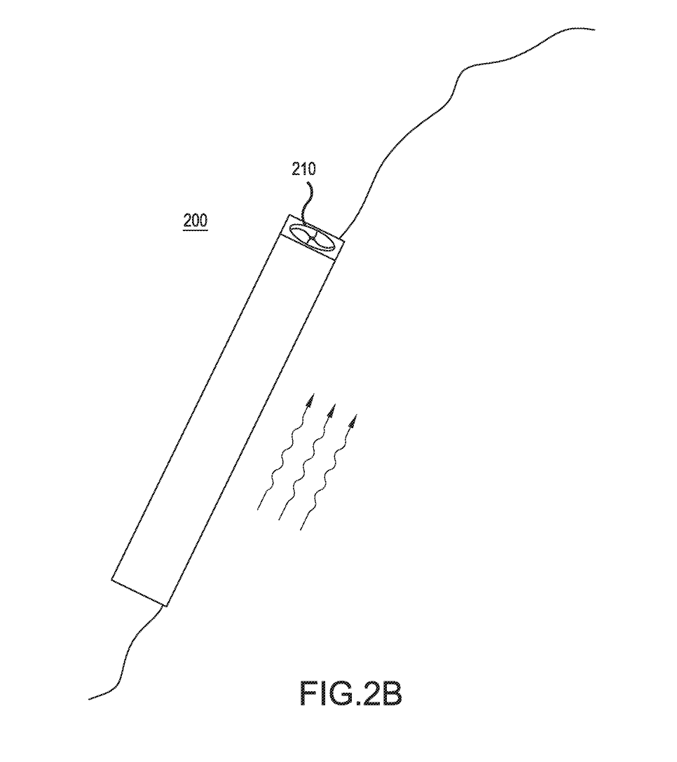

Referring now to FIGS. 2A and 2B, perspective views of thermal power generator 200 are shown in an exemplary use according to an aspect of an embodiment of the present invention. Here, generator 200 is positioned along the side of a mountain. Mountains typically experience rising air which rise from the mountain base up towards the peak. Air at the base, being warmer than air found towards the peak, typically rise because of its lower density. Generator 200, as positioned, would seek to take advantage of the airflow rising from the base of the mountain. Generator 200 may be characterized as having an outer structure 202 and an inner structure 204. The top of inner structure 204 may be open to allow airflow through it. Outer structure 202's surface may be transparent to allow solar rays to pass through it while inner structure 204 may be a blackened surface meant to capture all of the thermal radiation from the solar rays directed to the surface by a plurality of Fresnel lenses 208 directed to it. Here, the rising air would enter generator 200 from its base into the space 206 between outer and inner structures 202 and 204. The airflow may also enter interior enclosure 210 of inner structure 204. The airflow into generator 200 is then heated because of the directed rays onto the blackened surface of inner structure 204. Because of this heating, the heated air then flows upwards to turbine(s) 210 which rotate, as a result, to generate power.

Although this present invention has been disclosed with reference to specific forms and embodiments, it will be evident that a great number of variations may be made without departing from the spirit and scope of the present invention. For example, equivalent elements may be substituted for those specifically disclosed and certain features of the present invention may be used independently of other features—all without departing from the present invention as defined in the appended claims

What is claimed is:

1. A thermal power generator, comprising:
an outer structure, having a transparent surface, wherein the outer structure comprises of a chimney portion, the chimney portion having top and bottom portions;
an inner structure, having a darkened surface and positioned within the outer structure, wherein the inner structure comprises of an interior enclosure within;
at least one turbine mounted at the top of the chimney portion;
a channel leading from the interior enclosure's top to the at least one turbine; and
a plurality of Fresnel lenses, positioned around the circumference of the chimney's bottom portion, wherein the plurality of Fresnel lenses are angled to direct sun or solar rays onto the inner structure's surface.

2. The generator of claim 1, further comprising a plurality of air inlets at the outer structure's base.

3. The generator of claim 1 wherein the inner structure is made of a heat conductive metal.

4. The generator of claim 1 wherein the outer structure is made of and one of: glass, plastic.

5. The generator of claim 1, further comprising of a plurality of legs extending from the outer structure's base, wherein the legs enable air to enter space between the outer and inner structures.

6. The generator of claim 1, wherein the outer and inner structures are connected by a plurality of cross bars.
